(19) United States
(12) Patent Application Publication
(10) Pub. No.: US 2014/0014797 A1
(43) Pub. Date: Jan. 16, 2014

(54) UNIVERSAL CLAMPING ASSEMBLY AND ACCESSORIES THEREFOR

(71) Applicants: Ronald T. McSherry, Morrison, CO (US); Dennis Overton, Arvada, CO (US)

(72) Inventors: Ronald T. McSherry, Morrison, CO (US); Dennis Overton, Arvada, CO (US)

(73) Assignee: Gorilla Forks, LLC, Wheat Ridge, CO (US)

(21) Appl. No.: 13/549,073

(22) Filed: Jul. 13, 2012

(51) Int. Cl. F16B 2/12

(52) U.S. Cl. 248/231.41

(57) ABSTRACT

A universal bar clamp assembly for stationary load supports is made up of an elongated hollow guide rod having a first clamping member at one end and a second clamping member slidable along the cross bar toward and away from the first clamping member, a ratchet on the second clamping member establishes releasable locking engagement with the cross bar and the clamp members have interchangeable gripping pads according to the intended application of the assembly, and a socket adapter can be releasably connected to the cross bar to releasably support various articles from the clamping assembly.

### BACKGROUND AND FIELD OF INVENTION

The following relates to clamping devices and, more particularly, to a novel and improved universal clamping assembly that may be utilized in conjunction with load supports for handling, storage, and transport purposes. However, its use in conjunction with load supports is intended to be more as a setting for different features of the clamping assembly and by no means limited thereto.

There is a need for a clamping bar assembly which is conformable for use in conjunction with stationary load supports, such as, a wall, tree or post and mobile load supports, such as, ladders, hand trucks, dollies and the like so as to facilitate transportation or support of other articles. Furthermore, the clamping device may be mounted at different locations on the support structure for extension at different angles depending upon its intended use; and equally as important enables mounting of the clamping members to circular or non-circular cross-section rods or bars either together or in spaced relation to one another.

### SUMMARY OF INVENTION

A universal bar clamp assembly is characterized by its ability to be attached to a load support for various accessories but has particular utility in combination with ladder-like structures, such as for example, hand trucks and dollies. The bar clamp assembly is comprised of an elongated bar or guide rod having a threadedly adjustable first clamping member at one end, a second clamping member slidable along the length of the cross bar toward and away from the first clamping member, and a ratchet on the second clamping member establishing releasable locking engagement with the bar at a selected distance or spacing from the first clamping member in order to releasably clamp the bar assembly to a rigid support. The first and second clamping members are further characterized by having interchangeable clamping pads or surfaces which are readily conformable for secure clamping engagement with bars that may be of irregular cross-section or of different cross-sectional shapes, such as, oval, circular or rectangular.

### DETAILED DESCRIPTION OF THE DRAWINGS

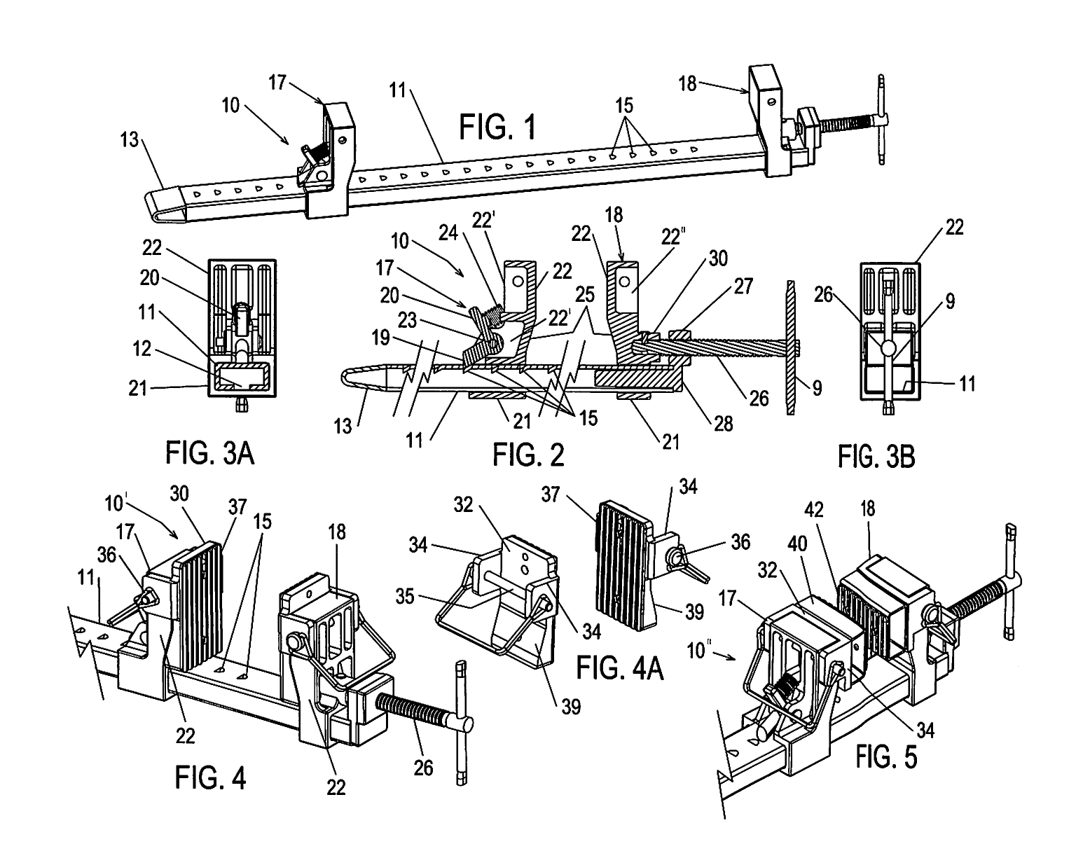

FIG. 1 is a perspective view of a first embodiment of an adjustable bar clamp;

FIG. 2 is a cross-sectional view of the embodiment shown in FIG. 1;

FIG. 3A is a rear view of the ratchet type clamping member mounted on the crossbar as shown in FIG. 1;

FIG. 3B is a front view of the end clamping member shown in FIG. 1;

FIG. 4 is a perspective view of a second embodiment, having a modified form of clamping member;

FIG. 4A is a perspective view of the modified clamping surfaces of the second embodiment shown in FIG. 4;

FIG. 5 is a perspective view of the third embodiment of a clamping member shown in FIG. 4;

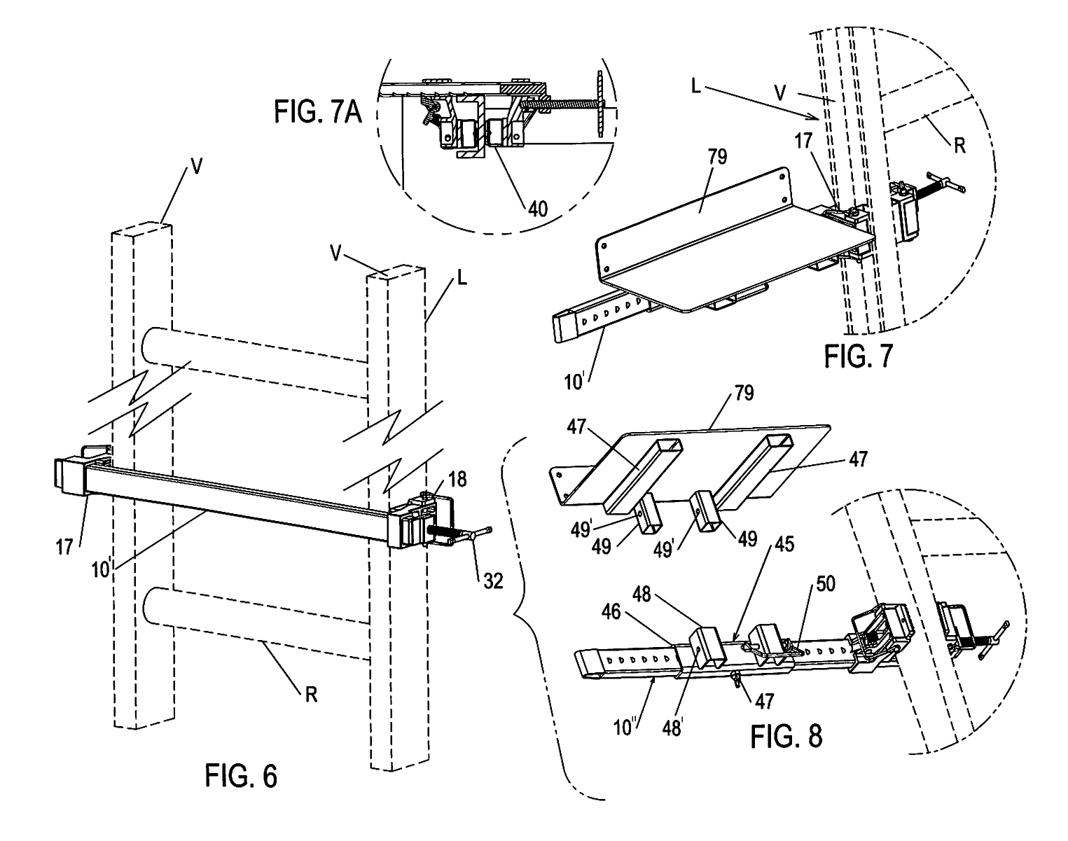

FIG. 6 is a perspective view of the adjustable bar clamp secured to a standard ladder;

FIG. 7 is an enlarged view of the clamping member shown in FIG. 5 attached to a channeled ladder;

FIG. 7A is a cross-sectional view of the ladder and clamp members of FIG. 7;

FIG. 8 is an exploded perspective view of the first embodiment in combination with a universal post adapter and shelf secured to a ladder;

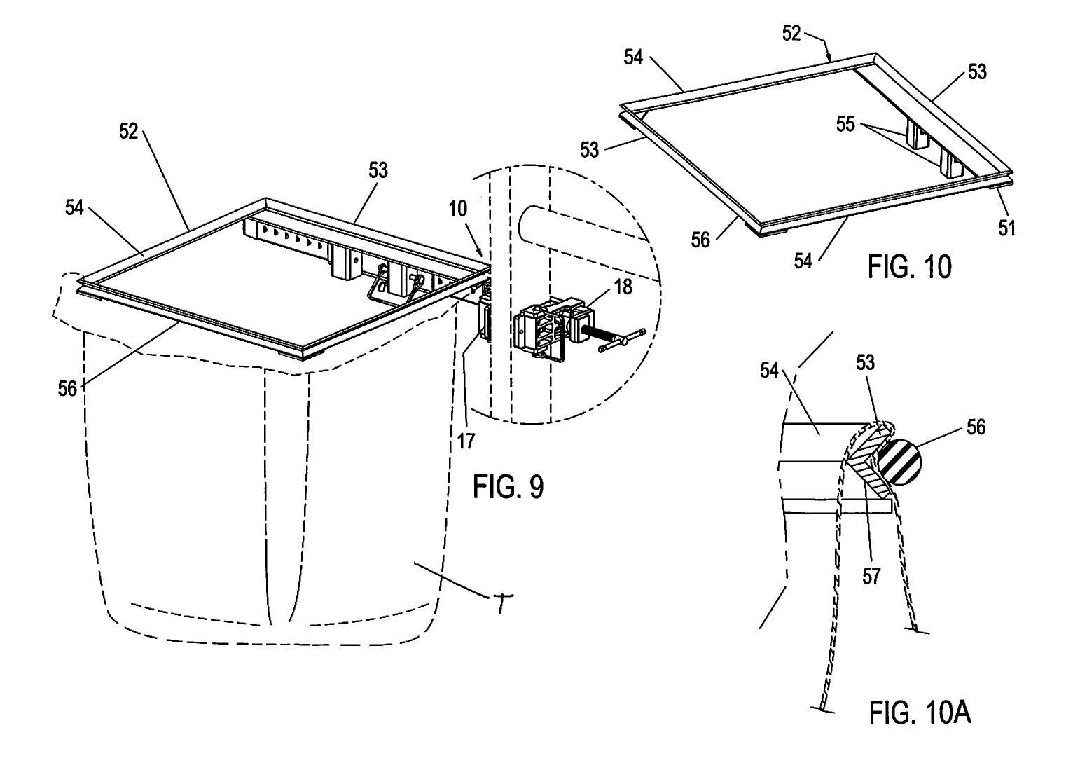

FIG. 9 is a perspective view of the first embodiment with a trash bag holder secured to a ladder;

FIG. 10 is a perspective view of a frame and portion of a frame holder for a bag;

FIG. 10A is an enlarged cross sectional view in detail of the frame and frame holder of FIGS. 9 and 10;

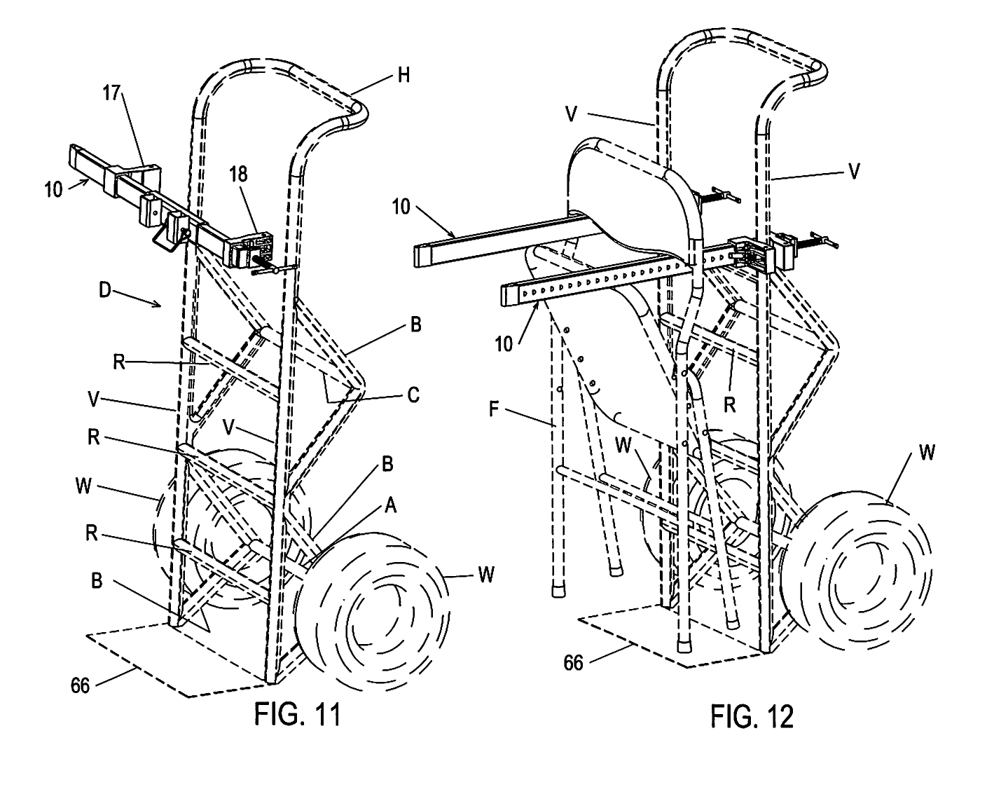

FIG. 11 is a perspective view of an adjustable bar clamp secured to a dolly;

FIG. 12 is a perspective view of a dual adjustable bar clamps mounted on a dolly;

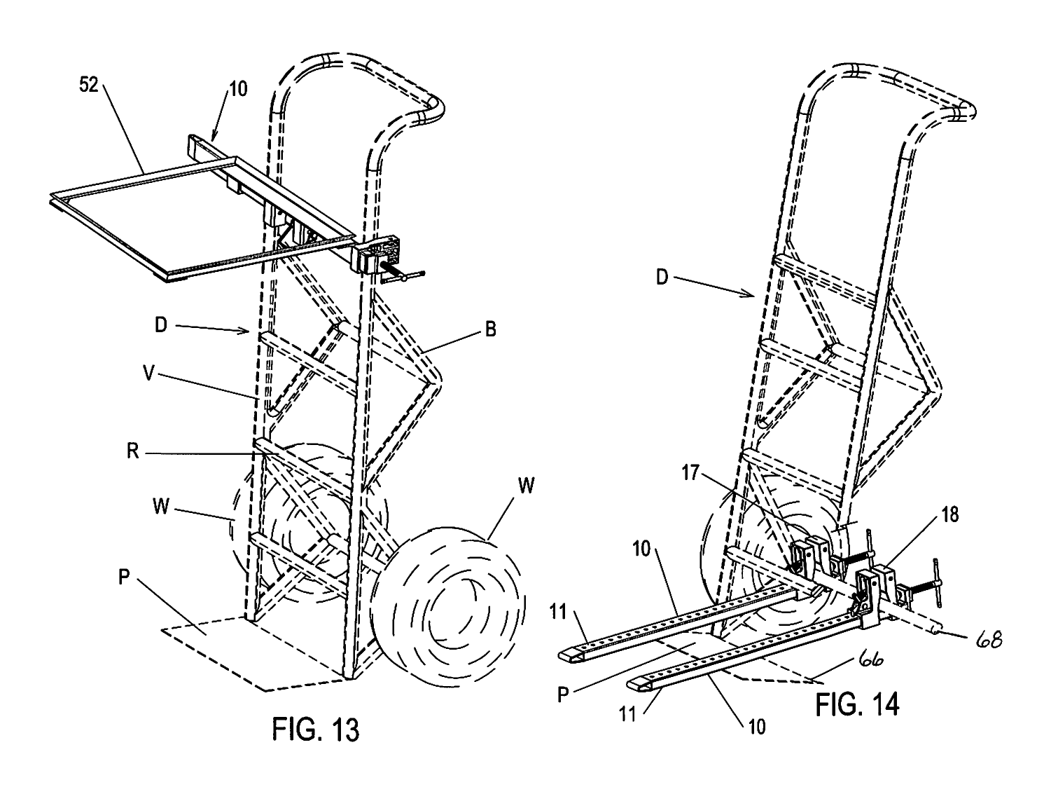

FIG. 13 is a perspective view of a trash bag and holder attached to a dolly; and

FIG. 14 is a perspective view of a dual clamp assembly mounted on the wheel axle of a hand truck.

### DETAILED DESCRIPTION OF FIRST EMBODIMENT

There is shown by way of illustrative example in FIGS. 1-6 first, second and third embodiments of a universal cross bar clamping assembly 10 having an elongated cross bar or guide rod 11 composed of a high strength material, such as, metal or hard plastic or rubber. Preferably the bar 11 is hollow and of generally rectangular cross-section with an elongated bottom slot 12 and terminates in a tapered nose plate extender 13. The bar 11 also has a series of spaced perforations or indentations 15 along its length for a slidable clamp member 17 to adjustably lock into place with respect to one of the indentations 15 in a manner to be described; and a clamping member 18 is mounted at one end of the bar 11 in facing relation to the clamping member 17 for slidable advancement over a limited distance at the end of the bar 11 in a manner to be described.

The clamping member 17 includes an open rectangular housing or sleeve 21 for slidable insertion of the bar 11, and a clamping plate 22 extends upwardly from the housing 21 with a recessed portion 22′ behind the plate 22 to receive a pivot pin 23 for a ratchet member made up of a lower leg or jaw member 19 and an upper leg or trigger 20 which bears against a spring 24. As best seen from FIG. 2, the spring 24 is mounted under compression between the clamping plate 22 and trigger 20 to normally urge the lower leg or jaw 19 downwardly into engagement with the upper surface of the bar 11. Accordingly, the clamping member 17 is free to advance along the length of the bar 11 without having to raise the ratchet member until it moves into position against an object to be clamped between the member 17 and 18; but when retracted away from the clamping member 18 the ratchet and specifically the jaw 19 will be free to move into locking position with the nearest perforation 15 unless the jaw 19 is manually raised above the upper surface of the bar 11.

The clamping member 18 similarly includes a housing or sleeve 21 corresponding to that of the clamping member 17 for slidable insertion of the bar 11 therethrough; and similarly includes an upstanding clamping plate 22 in facing, parallel relation to the plate 22 on the clamping member 17 and is recessed at 22″ as in the clamping member 17. Slidable advancement of the clamping member 18 is controlled by a threaded stem 26 which is mounted for advancement through a nut or threaded opening 27 fixed to a plug 28 inserted in the end of the bar 11; and the leading end of the stem 26 is journaled in a bearing 30 at the lower end of the clamping plate 22 so that when the stem 26 is rotated by handle 9 it will control the advancement of the clamping plate along the surface of the bar. Accordingly, when the clamping members 17 and 18 are moved toward one another into engagement with an object to be clamped, the clamping member 18 can be finely adjusted to compensate for any limited movement necessary to firmly clamp an object between the two clamping members 17 and 18. In addition, the clamping surfaces 22 have inclined receding surface portions 25 for gripping rounded members as well as uneven or inclined surface portions in a manner to be hereinafter described.

### DETAILED DESCRIPTION OF SECOND EMBODIMENT

FIGS. 4 and 4A illustrate a second embodiment of a universal clamp assembly 10′ in which elements corresponding to FIGS. 1-3B are correspondingly enumerated. In this embodiment, a clamping shoe 30 is comprised of a base plate 32 having side attachment wings 34, and a release pin 35 between the wings 34 may be threaded at opposite ends to receive a securing member 36 such as a D-clip or wing nuts. The plate 32 is surfaced with a rubber clamping pad 37 but it will be apparent that it can be surfaced with other materials as well depending upon the intended use of the assembly 10′ as later shown and described. Each plate 32 has a rear surface 39 conforming or complementary to the front surface of each clamping plate 22 and is assembled onto each clamping member 17 and 18 by extension of the pin 35 through openings in the wings 34 of the clamping member; and by securing the D-clip 36 at each end of the threaded rod 35, it will firmly attach the shoe 30 in place.

### DETAILED DESCRIPTION OF THIRD EMBODIMENT

FIGS. 5, 7 and 7A illustrate a third embodiment of a universal clamp assembly wherein once again elements corresponding to FIGS. 1-4A are correspondingly enumerated. As in the second embodiment, a clamping shoe 30 has a base plate 32 with side attachment wings 34, and a release pin 35 extends between the wings 34 and may have threaded ends to receive the securing member 36. The clamping shoe 30 is modified by having an extension in the form of a hollow or solid rectangular block 40 mounted on the base plate but with its longer dimension extending at right angles to the shoe 30. The block 40 is permanently attached to the shoe, such as, by welding and essentially doubles the spacing or distance between the back surface of the shoe 30 and front gripping pad 42 on the front surface of the block 40. The clamping pad 42 corresponds to the makeup of the clamping pad 37 but with its longer dimension being coextensive with that of the support block 40 so as to extend at right angles to the length of the cross bar 11. In all other respects, the clamping members 17 and 18 correspond to the clamping members 17 and 18 of the first and second embodiments.

As best seen from FIGS. 7 and 7A, the clamping pads or surfaces 42 of the third embodiment are dimensioned to fit into a grooved portion, such as, the channels along outsides or insides of the leg members of a channel type ladder construction and is intended to illustrate one application of the third embodiment.

FIGS. 6 to 10 illustrate use of the second and third embodiments described in combination with a ladder L. The ladder L is of conventional construction having leg members V interconnected by a series of vertically spaced, horizontally extending rungs R. The basic ladder L is representative of numerous ladder structures, such as, for example, channeled ladders, extension ladders, step ladders, etc. The clamping bar assembly 10 is shown in FIG. 6 extending crosswise of the ladder with the clamping members 17 and 18 being in spaced-apart relation and with the clamping pads or surfaces 36 slidably mounted on the bar 11 for lengthwise advancement forwardly and away from one another. The clamping members 17 and 18 have their leg-engaging clamping surfaces in facing relation to one another and slidable into engagement with the outsides of the leg members 10. In turn, the releasable locking member or ratchet 17 is movable into locking engagement with one of the indentations 15 nearest the most adjacent leg member 40, and the clamping member 18 is then advanced into engagement with the opposite leg member 40 by rotation of the handle 9. In this relation, the cross bar 11 extends parallel to the rungs R and may serve as a reinforcing member or support for various accessories, such as, paint cans, tools or cleaning utensils. Also, the cross bar can be equipped with a bracket to support a frame 45 for trash bags or other containers in a manner to be described. In the alternative, the clamping bar assembly 10 may be mounted for extension of the bar 11 perpendicular to the rungs R by mounting the clamping member 17 and 18 to opposite sides of one of the leg members V or of one of the rungs R, for example, as illustrated in FIGS. 7 and 8.

For the purpose of illustration but not limitation, FIGS. 7 and 8 illustrate mounting of the bar clamp assembly 10 for extension from one leg V, and the bar clamp assembly 10 is equipped with an adapter 45 made up of a rectangular sleeve 46 which is dimensioned to receive the cross bar 11 and is tightened onto the bar by a suitable threaded fastener 47 on the undersurface of the sleeve. The sleeve is also equipped with a pair of vertically extending sockets 48 in spaced relation to one another to facilitate mounting of different accessories to the clamp bar. In FIGS. 7 and 8 a shelf 79 is provided with male fasteners defined by downwardly extending tube supports 49 which are insertable into the sockets 48 and are provided with openings 49′ to align with the openings 48′ in the sockets for reseasable insertion of a suitable cross pin 50. Reinforcing tube supports 47 extend along the underside of the shelf 79.

FIG. 9 illustrates another application of the bar clamp assembly 10 in combination with the adapter 45 to facilitate mounting of a trash bag holder in the form of a rectangular frame 52 of the type illustrated in FIG. 10. The frame member 52 is merely representative of various different sizes and shapes of frames depending upon the particular opening size of trash bag T to be mounted. As illustrated, the frame 52 is of open rectangular configuration having grooved side and end frame members 53 and 54. One of the end frame members 53 is mounted on a reinforcing plate 51 for a pair of downwardly extending posts 55 sized for extension into the sockets 48 on the adapter 45. The upper open end of the trash bag T is folded over the frame members 53 and 54 and retained in place by suitable means such as, an elastic ring or bungee cord 56 inserted into the external grooves 57 in the frame members 53 and 54 as shown in FIG. 10A. A particular advantage of the frame 52 as described is that they can be easily released by removal of the pins 50 from the sockets 48, as shown in FIG. 8, and moved to another site or location or to facilitate emptying of the bag into a larger receptacle.

FIGS. 11 to 14 further illustrate the versatility of the universal bar clamp assemblies 10, 10′ when used in combination with a standard hand truck or dolly D. Typically, the dolly D is comprised of spaced parallel rungs R extending between a pair of elongated leg members V and which terminate in an upper handle H. A pair of wheels W are mounted at opposite ends of an axle A which extends between a pair of lower triangular braces B behind each leg member V. Similarly, a cross bar C extends between a pair of upper triangular braces B behind the leg members V. A platform member or pallet P is attached to the lower edge of the leg members V. The bar clamp assembly 10 is shown in FIG. 11 mounted across the upper ends of the leg members V in the same manner as described in FIGS. 6 to 10 with respect to a ladder L. It will be apparent that the assembly 10 may be mounted in different locations on the dolly D for various uses, such as, for the purpose of supporting a shelf 79 or a frame 52 as previously described in conjunction with the ladder support in FIGS. 6 to 10. In addition, FIG. 12 illustrates utilization of a pair of clamp assemblies 10 mounted on each of the leg members V in the same manner as described in reference to FIGS. 8 and 9 but for forward extension perpendicular to the legs V and in spaced parallel relation to one another over the pallet 66. In FIG. 12, the clamping bar assemblies are shown supporting a conventional folding chair F but may support a plurality of chairs F in stacked relation to one another in transporting to different locations; and a particular feature is to enable stacking in upright relation to one another so that, when the dolly D is tipped downwardly into a rolling position, will more evenly distribute the load over the length of the dolly D.

Similarly, FIG. 13 illustrates mounting of a trash bag holder 52 of the type described in connection with FIG. 10 but being centered in relation to the dolly D. In a similar manner, FIG. 14 illustrates mounting of a pair of clamping bar assemblies 10 on wheel axle 68. When the dolly D is in the upright stationary position, the clamping bars 11 are inclined downwardly over the pallet 66 to be either resting against or closely adjacent to the ground and in this way can be easily slid under an object, not shown, resting on the ground by tilting the object or load slightly until the bars 11 are centered beneath the load; and when the dolly D is tilted back will of course raise the load off the ground. FIG. 14 illustrates in particular the use of the clamping member 17 and 18 of the first embodiment with the curvilinear or inclined receding surfaces 25 on each of the clamping members 17 and 18 to grip a rounded member such as the wheel axle 68 and thereby prevent slippage or shifting once the clamping members are brought into firm engagement with the rounded member.

It is therefore to be understood that while different embodiments are hereinafter set forth and described, the above and other modifications may be made therein without departing from the spirit and scope of the invention as defined by the appended claims and reasonable equivalents thereof.

What is claimed is:

1. In a bar clamp assembly for releasable suspension from a load support member, the improvement comprising:
a cross bar extending between and slidably engaging spaced locations on said support member, said bar having a pair of clamp members slidably mounted thereon for lengthwise advancement toward and away from one another, said clamp members including support member-engaging clamping surfaces in facing relation to one another, and a releasable locking member on each said clamp members engageable with said bar and wherein said bar is movable between a first position traversing said support member and in parallel relation to said support member with said clamping surfaces in clamping engagement with spaced locations on said support member and a second position in which said bar is mounted on said support member and extends perpendicular to said support members.

2. In a bar clamp assembly according to claim 1 wherein a pair of cross bars are clamped to said support member in spaced parallel relation to one another for extension perpendicular to said support member.

3. In a bar clamp assembly according to claim 1 wherein said cross bar is defined by a longitudinally extending guide rod having indentations at longitudinally spaced intervals along a top surface of said rod.

4. In a bar clamp assembly according to claim 3 wherein said clamp members have guide rod openings, clamp shoes provided with substantially flat jaw surfaces in parallel facing relation to one another and lower receding jaw surfaces engageable with a rounded portion of said support member.

5. In a bar clamp assembly according to claim 4 wherein said jaw surfaces are releasably attached to said respective clamp shoes, and interchangeable clamping pads are mounted on said jaw surfaces.

6. In a bar clamp assembly according to claim 5 wherein each clamp shoe is provided with a mounting block for mounting each of said respective jaw surfaces in spaced relation to each respective one of said clamp shoes.

7. In a bar clamp assembly according to claim 1 wherein an adapter sleeve is releasably mounted on said cross bar, said adapter sleeve having spaced parallel sockets extending perpendicular to said cross bar, and a holder is releasably attached to said sockets.

8. In a bar clamp assembly according to claim 7 wherein said holder is in the form of a shelf having male fasteners releasably inserted into said sockets.

9. In a bar clamp assembly according to claim 7 wherein a bag holder frame is provided with male fasteners for releasable insertion into said sockets, said frame including an elastic band insertable into grooves in said frame for releasable suspension of a bag therefrom.

10. In a bar clamp assembly for connection to a ladder-like support of the type having a plurality of spaced parallel rungs rigidly connected to and extending between a pair of elongated leg members, the improvement comprising:
a cross bar extending between and slidably engaging one or both of said leg members, said bar having a pair of clamp members slidably mounted thereon for lengthwise advancement toward and away from one another, said clamp members including leg-engaging clamping surfaces in facing relation to one another, and a releasable locking member on each said clamp member engageable with said bar and wherein said bar is movable between a first position traversing said leg members and in parallel relation to said rungs with said clamping surfaces in clamping engagement with opposite sides of said leg members and a second position in which said bar extends perpendicular to one of said leg members wherein said clamping surfaces are in clamping engagement to opposite sides of said one of said leg members.

11. In a bar clamp assembly according to claim 10 wherein a pair of cross bars are clamped to said support for extension perpendicular to said leg members and in spaced parallel relation to one another.

12. In a bar clamp assembly according to claim 10 wherein said cross bar is defined by a longitudinally extending guide rod having perforations along a top surface of said rod;
said clamp members each having a housing with a lower guide rod opening and upper facing, parallel jaw surfaces.

13. In a bar clamp assembly according to claim 9 wherein said jaw surfaces have parallel and inclined receding portions for securement to said rod.

14. In a bar clamp assembly according to claim 12 wherein one of said clamping members include ratchet means for advancing said one clamping member along said guide rod, and another of said clamping members having a threaded opening for advancement and retraction of said other of said clamping members from a fixed adjustment member mounted on one end of said guide rod.

15. In a bar clamp assembly according to claim 14 wherein each of said guide rods is provided with a tapered tip extending from a free end thereof.

16. In a bar clamp assembly for use in combination with a hand truck of the type having spaced parallel rungs rigidly connected to and extending between a pair of elongated leg members, an upper handle member, a lower platform member and a wheel and axle assembly, the improvement comprising:
a cross bar extending between and slidably engaging one or both of said leg members having a pair of clamp members slidably mounted thereon for lengthwise advancement toward and away from one another, said clamp members including leg-engaging clamping surfaces in facing relation to one another, and a releasable locking member on each said clamp member engageable with said bar and wherein said bar is movable between a first position traversing said leg members and in parallel relation to said rungs with said clamping surfaces in clamping engagement with opposite sides of said leg members and a second position in which said bar extends perpendicular to one of said leg members and said clamping surfaces are in clamping engagement with said support.

17. In a bar clamp assembly according to claim 16 wherein said cross bar is hollow and of generally rectangular cross section with perforations at spaced longitudinal intervals along one surface thereof.

18. In a bar clamp assembly according to claim 17 wherein a pair of said cross bars are clamped to said wheel and axle assembly for extension perpendicular to said rungs, each of said cross bars terminating in a tapered extension at a free end thereof.

19. In combination, an adjustable bar clamp assembly for securing a load on a load-carrying member, comprising:
a longitudinally extending guide rod having indentations along a top surface of said rod;
first and second clamping members each having a housing defined by a lower guide rod opening and upper jaw surfaces having complementary parallel and inclined portions for securement to said load-carrying member, and clamping pads interchangeably mounted on said jaw surfaces;
said first clamping member having a ratchet member engageable with a selected one of said indentations to control advancement of said first clamping member along said guide rod; and
said second clamping member having a threaded opening for advancement and retraction of said clamping member from a fixed adjustment member mounted on one end of said guide rod.

20. A manually adjustable attachment used in combination with a hand truck, the hand truck comprising dual vertical support members and spaced horizontal support members, an upper handle member, a lower platform member, and a wheel and axle assembly, comprising:
a longitudinally extending guide rod having perforations along a top surface of said rod;
first and second clamping members each having a housing defined by a lower guide rod opening and upper curvilinear jaw surfaces wherein said surfaces have complementary linear and curved portions for securement to said load carrying member;
said first clamping member having a ratchet member to control advancement of said first clamping member along said guide rod;
said second clamping member having a threaded opening for advancement and retraction of said clamping member from a fixed adjustment member mounted on end of said guide rod;
a sleeve member wherein said sleeve member is slidable over said guide rod; and
said sleeve member having a locking member and at least one post adapter secured along a surface of said sleeve member, said post adapter having post-receiving openings, a quick release pin member and opening for said pin member to pass therethrough.

21. A removable attachment used in combination with a support member, the support member comprising dual vertical support members and spaced horizontal support members, comprising:
a longitudinally extending guide rod having squared sidewalls and perforations along a top surface of said rod;
first and second clamping members each having a housing defined by a lower guide rod opening and upper jaw surfaces wherein said surfaces have complementary flat parallel portions for securement to said support member;
said first clamping member having means for controlling advancement of said first clamping member along said guide rod;
said second clamping member having a threaded opening for advancement and retraction of said clamping member from a fixed adjustment member mounted on end of said guide rod;
a sleeve member wherein said sleeve member is adapted to slide over said guide rod;
said sleeve member having a locking member and at least one post adapter secured along a surface of said sleeve member; said post adapter having post receiving openings, a quick release pin member and opening for said pin member to pass therethrough;
a support member having at least one post member for placement in said post receiving openings; said support member having an open frame member for placement of a trash bag over exposed edges of said frame member; and securing device.
